(19) United States
(12) Patent Application Publication
(10) Pub. No.: US 2016/0314560 A1
(43) Pub. Date: Oct. 27, 2016

(54) IMAGE DISPLAYING METHOD, APPARATUS, AND DEVICE, AND COMPUTER PROGRAM PRODUCT

(71) Applicants: LE HOLDINGS (BEIJING) CO., LTD., Beijing (CN); LE SHI INTERNET INFORMATION TECHNOLOGY CORP. BEIJING, Beijing (CN)

(72) Inventors: Fengyu ZHANG, Beijing (CN); Shibin LI, Beijing (CN); Haibo WU, Beijing (CN)

(21) Appl. No.: 15/102,565

(22) PCT Filed: Dec. 8, 2014
(86) PCT No.: PCT/CN2014/093293

§ 371 Date: Jun. 8, 2016

(30) Foreign Application Priority Data
Dec. 9, 2013 (CN) 201310686424.3

(51) Int. Cl. G06T 3/40

(52) U.S. Cl. CPC G06T 3/40

(57) ABSTRACT

Disclosed are an image displaying method, apparatus, and device. The image displaying method comprises the following steps: receiving, after a to-be-scanned image is displayed to a user, an image enlargement request for the to-be-scanned image from the user; enlarging the to-be-scanned image according to a preset enlargement rule; and displaying the enlarged to-be-scanned image to the user. The technical solutions of the present invention can solve the problems, in the prior art, of poor flexibility of scanning an image by a user, a low scanning success rate, and a long scanning response time.

This application claims the benefit of Chinese Patent Application No. 201310686424.3, filed with the State Intellectual Property Office of People's Republic of China on Dec. 9, 2013 and entitled “Image presenting method and apparatus”, which is hereby incorporated by reference in its entirety.

### FIELD

The present disclosure relates to the field of image processing and particularly to an image presenting method, apparatus, device, and computer program product.

### BACKGROUND

QR (Quick Response) code is a pattern of alternating black and white bars, regularly distributed in a plane (two-dimension directions), and digits, texts, pictures, or other information are stored in the QR code. The QR code can be scanned to recognize and process automatically the information stored in the QR code. In real life, the QR code technologies can be applied to product anti-counterfeiting/tracing, advertisement recommendation, website links, data downloads, commodity trading, positioning/navigation, electronic certificates, vehicle management, information passing, name card exchanges, Wireless Fidelity (WiFi) sharing, and other technology fields.

In daily life, the QR code scanning technologies are frequently seen in subways, bus stops, WeChat, microblogs, and other scenarios in which QR code can be scanned at a short distance, that is, a user needs to hold a mobile terminal so as to scan a QR code image at a short distance. Along with the rapid development of the smart TV technologies, the QR code scanning technologies may often be used when the users watch a smart TV, for example, the users can scan a QR code image presented on the smart TV for the purpose of logging into an account, downloading data, trading a commodity, etc., to thereby simplify operations of the user. However there is typically a distance of 2 to 3 meters between the user and the smart TV, so the user scan the QR code image presented on the smart TV at a long distance; and as well known, the size of the QR code image is small and often distributed among various texts or images, as illustrated in FIG. 1, so it may be very likely for the scanning user to fail to have the QR code image scanned, and then the user will approach the smart TV and scan again, which may make it inconvenient for the user to watch the smart TV normally, thus resulting in poor flexibility with scanning the QR code image as well as lowering the success ratio of scanning the image and prolonging a response period of time in scanning the QR code image.

Moreover the user scanning other types of image (e.g., a one-dimension strip code image) presented on the smart TV may also be faced with the problems above.

### SUMMARY

Embodiments of the disclosure provide an image presenting method, apparatus, device, and computer program product so as to address the problems in the prior art of the poor flexibility in scanning the image by the user, the quite low success ratio of scanning the image, and the long response period of time in scanning the image.

Technical solutions according to the embodiments of the disclosure are as follows:

An embodiment of the disclosure provides an image presenting method including:

receiving an image enlargement request of a user for a to-be-scanned image, after the to-be-scanned image is presented to the user;

enlarging the to-be-scanned image under a preset enlargement rule; and presenting the enlarged to-be-scanned image to the user.

As can be apparent, in the technical solution according to the embodiment of the disclosure, after the image enlargement request of the user for the to-be-scanned image is received, the to-be-scanned image can be enlarged and then presented to the user so that the user can scan the enlarged image so as to avoid a failure in scanning the to-be-scanned image, which may arise from the small size thereof, thus improving the success ratio of scanning without the need for the user to approach the smart TV and to scan again, which can improve the flexibility of scanning the image and also shorten a response period of time in scanning the image.

As an embodiment, receiving the image enlargement request of the user for the to-be-scanned image includes:

determining that the image enlargement request of the user for the to-be-scanned image is received, upon detecting a focus remaining on the to-be-scanned image, for a longer time length than a preset time length.

With the technical solution according to this embodiment, the user can trigger the operation of enlarging the to-be-scanned image, by moving the focus without the need for the user to approach the smart TV for scanning the image, thus improving the flexibility of scanning the image

As an embodiment, receiving the image enlargement request of the user for the to-be-scanned image includes:

determining that the image enlargement request of the user for the to-be-scanned image is received, upon detecting a click operation performed by the user on the to-be-scanned image.

With the technical solution according to this embodiment, the user can trigger the operation of enlarging the to-be-scanned image, by clicking on the to-be-scanned image, through a remote controller without the need for the user to approach the smart TV for scanning the image, thus improving the flexibility of scanning the image

As an embodiment, enlarging the to-be-scanned image, under the preset enlargement rule includes:

determining a size of the enlarged to-be-scanned image, according to a size of the to-be-scanned image, and a size of a preset display area; and

enlarging the to-be-scanned image according to the determined size of the enlarged to-be-scanned image.

With the technical solution according to this embodiment, after the enlargement request of the user for the to-be-scanned image is received, the to-be-scanned image is enlarged directly to the maximum size so that the scanning user can readily have the image scanned, thus improving the success ratio of scanning the image.

As an embodiment, enlarging the to-be-scanned image, under the preset enlargement rule includes:

determining whether the enlarged to-be-scanned image enlarged by a preset multiple goes beyond a boundary of a preset display area;

enlarging the to-be-scanned image by the preset multiple if the enlarged to-be-scanned image enlarged by the preset multiple does not go beyond the boundary of the preset display area;

determining a size of the enlarged to-be-scanned image, according to a size of the to-be-scanned image, and a size of the preset display area, and enlarging the to-be-scanned image according to the determined size of the enlarged to-be-scanned image, if the enlarged to-be-scanned image enlarged by the preset multiple goes beyond the boundary of the preset display area.

With the technical solution according to this embodiment, the to-be-scanned image is enlarged step by step in such a way that the to-be-scanned image is enlarged by a preset multiple each time the enlargement request of the user for the to-be-scanned image is received, until it is enlarged to the maximum size, so that the user can adjust freely the size of the to-be-scanned image, thus improving the flexibility of scanning the image.

As an embodiment, the to-be-scanned image is a one-dimension strip code image or a QR code image.

An embodiment of the disclosure provides an image presenting apparatus including:

a first image presenting unit configured to present a to-be-scanned image to a user;

an enlargement request receiving unit configured to receive an image enlargement request of the user for the to-be-scanned image;

an image enlarging unit configured to enlarge the to-be-scanned image under a preset enlargement rule; and

a second image presenting unit configured to present to the user the to-be-scanned image enlarged by the image enlarging unit.

As can be apparent, in the technical solution according to the embodiment of the disclosure, after the image enlargement request of the user for the to-be-scanned image is received, the to-be-scanned image can be enlarged and then presented to the user so that the user can scan the enlarged image so as to avoid a failure in scanning the to-be-scanned image, which may arise from the small size thereof, thus improving the success ratio of scanning without the need for the user to approach the smart TV and to scan again, which can improve the flexibility of scanning the image and also shorten a response period of time in scanning the image.

As an embodiment, the enlargement request receiving unit is configured to determine that the image enlargement request of the user for the to-be-scanned image is received, upon detecting a focus remaining on the to-be-scanned image, for a longer time length than a preset time length.

With the technical solution according to this embodiment, the user can trigger the operation of enlarging the to-be-scanned image, by moving the focus without the need for the user to approach the smart TV for scanning the image, thus improving the flexibility of scanning the image.

As an embodiment, the enlargement request receiving unit is configured to determine that the image enlargement request of the user for the to-be-scanned image is received, upon detecting a click operation performed by the user on the to-be-scanned image.

With the technical solution according to this embodiment, the user can trigger the operation of enlarging the to-be-scanned image, by clicking on the to-be-scanned image, through a remote controller without the need for the user to approach the smart TV for scanning the image, thus improving the flexibility of scanning the image.

As an embodiment, the image enlarging unit includes:

a first size determining sub-unit configured to determine a size of the enlarged to-be-scanned image, according to a size of the to-be-scanned image, and a size of a preset display area; and

a first image enlarging sub-unit configured to enlarge the to-be-scanned image according to the size, determined by the first size determining sub-unit, of the enlarged to-be-scanned image.

With the technical solution according to this embodiment, after the enlargement request of the user for the to-be-scanned image is received, the to-be-scanned image is enlarged directly to the maximum size so that the scanning user can readily have the image scanned, thus improving the success ratio of scanning the image.

As an embodiment, the image enlarging unit includes:

a determining sub-unit configured to determine whether the enlarged to-be-scanned image enlarged by a preset multiple goes beyond a boundary of a preset display area;

a second image enlarging sub-unit configured to enlarge the to-be-scanned image by the preset multiple when it is determined by the determining sub-unit that the enlarged to-be-scanned image enlarged by the preset multiple does not go beyond the boundary of the preset display area;

a second size determining sub-unit configured to determine a size of the enlarged to-be-scanned image, according to a size of the to-be-scanned image, and a size of the preset display area, when it is determined by the determining sub-unit that the enlarged to-be-scanned image enlarged by the preset multiple goes beyond the boundary of the preset display area; and

a third image enlarging sub-unit configured to enlarge the to-be-scanned image according to the size, determined by the second size determining sub-unit, of the enlarged to-be-scanned image.

With the technical solution according to this embodiment, the to-be-scanned image is enlarged step by step in such a way that the to-be-scanned image is enlarged by a preset multiple each time the enlargement request of the user for the to-be-scanned image is received, until it is enlarged to the maximum size, so that the user can adjust freely the size of the to-be-scanned image, thus improving the flexibility of scanning the image.

As an embodiment, the to-be-scanned image, which is received by the enlargement request receiving unit is a one-dimension strip code image or a QR code image.

An embodiment of the disclosure provides an image presenting device including the image presenting apparatus including:

a first image presenting unit configured to present a to-be-scanned image to a user;

an enlargement request receiving unit configured to receive an image enlargement request of the user for the to-be-scanned image;

an image enlarging unit configured to enlarge the to-be-scanned image under a preset enlargement rule; and

a second image presenting unit configured to present to the user the to-be-scanned image enlarged by the image enlarging unit.

As an embodiment, the enlargement request receiving unit is configured to determine that the image enlargement request of the user for the to-be-scanned image is received, upon detecting a focus remaining on the to-be-scanned image, for a longer time length than a preset time length.

As an embodiment, the enlargement request receiving unit is configured to determine that the image enlargement request of the user for the to-be-scanned image is received, upon detecting a click operation performed by the user on the to-be-scanned image.

As an embodiment, the image enlarging unit includes:

a first size determining sub-unit configured to determine a size of the enlarged to-be-scanned image, according to a size of the to-be-scanned image, and a size of a preset display area; and

a first image enlarging sub-unit configured to enlarge the to-be-scanned image, according to the size, determined by the first size determining sub-unit, of the enlarged to-be-scanned image.

As an embodiment, the image enlarging unit includes:

a determining sub-unit configured to determine whether the enlarged to-be-scanned image enlarged by a preset multiple goes beyond a boundary of a preset display area;

a second image enlarging sub-unit configured to enlarge the to-be-scanned image by the preset multiple when it is deteremined by the determining sub-unit that the enlarged to-be-scanned image enlarged by the preset multiple does not go beyond the boundary of the preset display area;

a second size determining sub-unit configured to determine a size of the enlarged to-be-scanned image, according to a size of the to-be-scanned image, and a size of the preset display area, when it is determined by the determining sub-unit that the enlarged to-be-scanned image enlarged by the preset multiple goes beyond the boundary of the preset display area; and

a third image enlarging sub-unit configured to enlarge the to-be-scanned image, according to the size, determined by the second size determining sub-unit, of the enlarged to-be-scanned image.

As an embodiment, the to-be-scanned image, which is received by the enlargement request receiving unit is a one-dimension strip code image, a QR code image or a text image.

An embodiment of the disclosure provides an image presenting device including a memory, and one or more processors, wherein the image presenting device further includes:

one or more units, stored in the memory, configured to be executed by the one or more processors, wherein the one or more units include instructions for performing steps of:

receiving an image enlargement request of a user for a to-be-scanned image, after the to-be-scanned image is presented to the user;

enlarging the to-be-scanned image under a preset enlargement rule; and

presenting the enlarged to-be-scanned image to the user.

An embodiment of the disclosure provides a commuter program product to be used in combination with an image presenting device, the commuter program product including a computer readable storage medium, and a computer program mechanism embedded therein, wherein the computer program mechanism includes instructions for performing steps of:

receiving an image enlargement request of a user for a to-be-scanned image, after the to-be-scanned image is presented to the user;

enlarging the to-be-scanned image under a preset enlargement rule; and

presenting the enlarged to-be-scanned image to the user.

### BRIEF DESCRIPTION OF THE DRAWINGS

In order to make the technical solutions according to the embodiments of the disclosure more apparent, the drawings to which reference is made in the description of the embodiments will be described below briefly, and apparently the drawings in the description below merely illustrate some embodiments of the disclosure, but those ordinarily skilled in the art can further derive from these drawings other drawings without any inventive effort. In the drawings:

FIG. 1 is a schematic diagram of the QR code images presented on the smart TV in the prior art;

FIG. 2 is a schematic flow chart of an image presenting method according to a first embodiment of the disclosure;

FIG. 3 is a schematic diagram of a to-be-scanned image before enlargement, according to the first embodiment of the disclosure;

FIG. 4 is a schematic diagram of a to-be-scanned image, which is enlarged, according to the first embodiment of the disclosure;

FIG. 5 is a schematic structural diagram of an image presenting apparatus according to a second embodiment of the disclosure;

FIG. 6 is a schematic structural diagram of an image presenting device according to a third embodiment of the disclosure; and

FIG. 7 is a schematic structural diagram of an image presenting device according to a fourth embodiment of the disclosure.

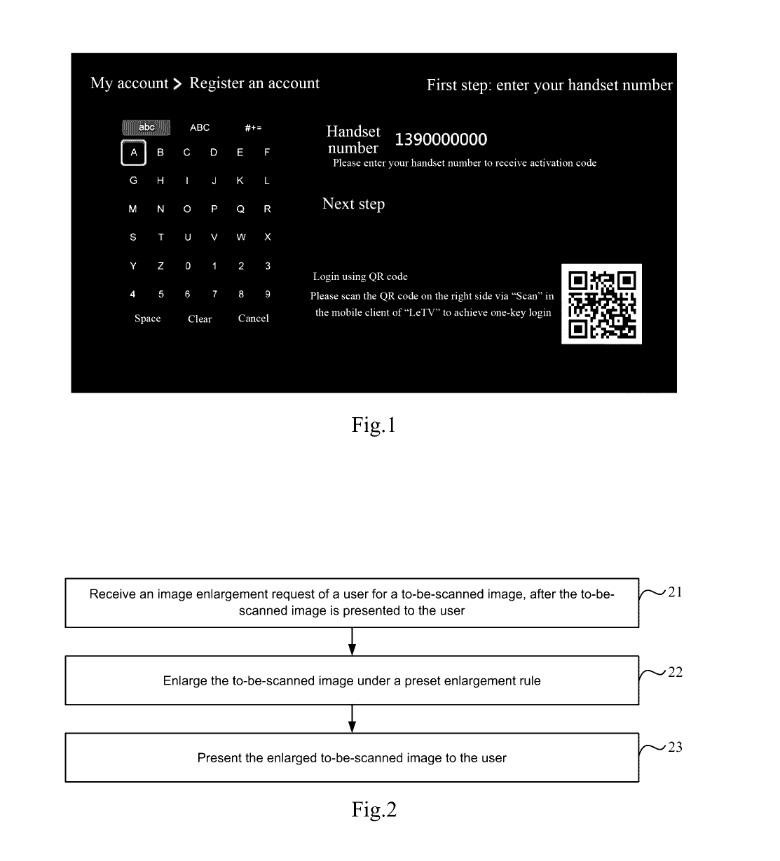

### DETAILED DESCRIPTION OF THE EMBODIMENTS

In order to make the objects, technical solutions, advantages of the disclosure more apparent, the disclosure will be described below in further details with reference to the drawings, and apparently the embodiments to be described below are only a part but not all of the embodiments of the disclosure. All the other embodiments that can be derived by those ordinarily skilled in the art based upon the embodiments here of the disclosure without any inventive effort shall fall into the claimed scope of the disclosure.

In the prior art, the user scanning the image (the QR code image or the one-dimension strip code image) presented on the smart TV needs to scan it at a long distance; and the size of the image is small and often distributed among various texts or images, so it may be very likely for the scanning user to fail to have the image scanned, and then the user will approach the smart TV for scanning, which may make it inconvenient for the user to watch the smart TV normally, thus resulting in poor flexibility with scanning the image, and also prolonging a response period of time in scanning the image.

In view of this, an embodiment of the disclosure provides an image presenting method, where after an image enlargement request of a user for a to-be-scanned image is received, the to-be-scanned image can be enlarged and then presented to the user so that the user can scan the enlarged image so as to avoid a failure in scanning the to-be-scanned image, which may arise from the small size thereof, thus improving the success ratio of scanning without the need for the user to approach the smart TV and to scan again, which can improve the flexibility of scanning the image and also shorten a response period of time in scanning the image.

The inventive technical solution will be described below in details with reference to embodiments thereof, and of course, the disclosure will not be limited to the following embodiments.

### First Embodiment

As illustrated in FIG. 2, there is a flow chart of an image presenting method according to the first embodiment of the disclosure, where a particular process thereof is as follows:

The step 21 is to receive an image enlargement request of a user for a to-be-scanned image, after the to-be-scanned image is presented to the user.

Here the to-be-scanned image can be but will not be limited to a one-dimension strip code image or a QR code image.

After the smart TV presents the to-be-scanned image, to the user on a display screen, if the user determines that it is unlikely for the to-be-scanned image, to be scanned successfully due to a small size of the presented to-be-scanned image, then the user can trigger an operation of enlarging the to-be-scanned image, through a digital remote controller, and in the first embodiment of the disclosure, the operation of enlarging the to-be-scanned image can be triggered in the following two particular modes without any limitation thereto:

In a first trigger mode, the user moves the focus through the digital remote controller to position the focus onto the to-be-scanned image, and if the smart TV detects that the focus remains on the to-be-scanned image, for a longer time length than a preset time length, then the smart TV can determine that the user intends to trigger the operation of enlarging the to-be-scanned image, so the smart TV will determine that the image enlargement request of the user for the to-be-scanned image is received.

For example, if the preset time length is two seconds, and the smart TV detects that the focus is moved by the user onto the to-be-scanned image and remains on the to-be-scanned image for more than two seconds, then the smart TV can determine that the user intends to trigger the operation of enlarging the to-be-scanned image.

In a second trigger mode, the user moves the focus through the digital remote controller to position the focus onto the to-be-scanned image, and then the user clicks on an “OK” button on the digital remote controller, that is, the user clicks on the to-be-scanned image, and at this time it can be determined that the user intends to trigger the operation of enlarging the to-be-scanned image, so it will be determined that the image enlargement request of the user for the to-be-scanned image is received.

The step 22 is to enlarge the to-be-scanned image under a preset enlargement rule.

In the first embodiment of the disclosure, in order to enable the scanning user to readily have the target image scanned, the to-be-scanned image can be enlarged directly to the maximum size after the image enlargement request of the user for the to-be-scanned image is received, where a preset display area, in which the to-be-scanned image is to be presented, is pre-selected in a display area of the display screen, and if at least two of the sides of the to-be-scanned image are located on the boundary of the preset display area, and the other sides are located in the preset display area, then at this time the size of the to-be-scanned image will be the maximum size; and if the to-be-scanned image is further enlarged, then the at least two sides of the to-be-scanned image will be located out of the preset display area.

The to-be-scanned image is enlarged by firstly determining the size of the to-be-scanned image, and the size of the preset display area, then determining the size of the enlarged to-be-scanned image, according to the size of the to-be-scanned image, and the size of the preset display area, and next enlarge the to-be-scanned image according to the determined size of the enlarged to-be-scanned image.

As an embodiment, the preset display area in which the to-be-scanned image is to be presented can be the entire display area of the display screen, that is, the to-be-scanned image will be enlarged directly throughout the screen after the image enlargement request of the user for the to-be-scanned image is received.

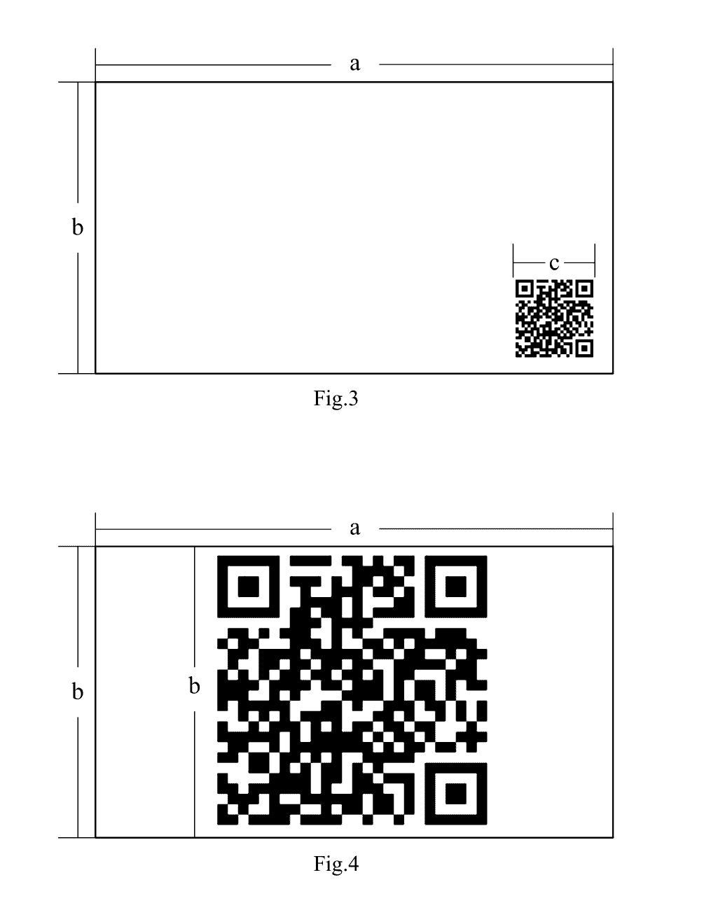

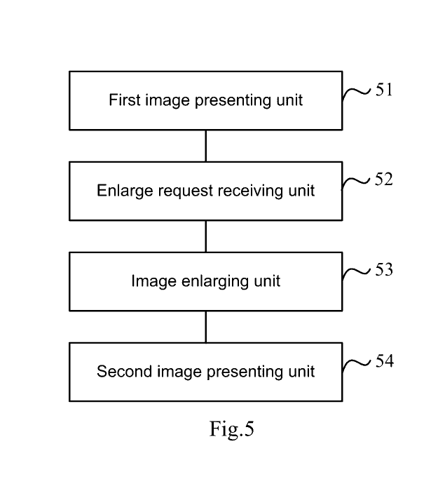

For example, if the width and the height of the preset display area are a and b, where a is more than b, then as illustrated in FIG. 3, the size of the to-be-scanned image before enlargement is c*c, that is, both the width and the height are c, and as illustrated in FIG. 4, both the height and the width of the enlarged to-be-scanned image are b, which is the same as the height of the preset display area, so the size of the enlarged to-be-scanned image is b*b.

In the first embodiment of the disclosure, the to-be-scanned image can be enlarged through matrix transformation, that is, the to-be-scanned image is regarded as a matrix of pixels composed of pixel values of respective pixels, a transform matrix for enlarging the to-be-scanned image is determined according to the size of the to-be-scanned image before enlargement, and the size of the enlarged to-be-scanned image, and then the matrix of pixels of the to-be-scanned image before enlargement is multiplied with the transform matrix, thus resulting in a matrix of pixels of the enlarged to-be-scanned image.

Moreover in the first embodiment of the disclosure, with the technical solution according to this embodiment, the to-be-scanned image can be enlarged step by step in such a way that the to-be-scanned image is enlarged by a preset multiple each time the enlargement request of the user for the to-be-scanned image is received, until it is enlarged to the maximum size, so that the user can adjust freely the size of the to-be-scanned image, thus improving the flexibility of scanning the image.

The enlarged to-be-scanned image after each enlargement is likely to go beyond the boundary of the preset display area, so before each enlargement of the to-be-scanned image, firstly it will be determined whether the enlarged to-be-scanned image enlarged by the preset multiple goes beyond the boundary of the preset display area, and if a result of the determination is negative, then the to-be-scanned image will be enlarged by the preset multiple; if a result of the determination is positive, the to-be-scanned image will be enlarged to the maximum size, where the size of the to-be-scanned image, and the size of the preset display area are determined, then the size of the enlarged to-be-scanned image is determined according to the size of the to-be-scanned image, and the size of the preset display area, and next the to-be-scanned image is enlarged according to the determined size of the enlarged to-be-scanned image.

For example, the preset multiple is 2, and after the smart TV presents the to-be-scanned image to the user, the user determines that it is unlikely for the to-be-scanned image, to be scanned successfully, so the user can trigger the operation of enlarging the to-be-scanned image, in the first trigger mode or the second trigger mode, and the smart TV can determine whether the enlarged to-be-scanned image enlarged by twice goes beyond the boundary of the preset display area, and if a result of the determination is negative, then the smart TV will present the to-be-scanned image enlarged by twice to the user; and if the user still determines that it is unlikely for the to-be-scanned image, to be scanned successfully, then the user can further trigger the operation of enlarging the to-be-scanned image, and the smart TV can determine whether the enlarged to-be-scanned image further enlarged twice goes beyond the boundary of the preset display area, and if so, then the smart TV will enlarge the to-be-scanned image, to the maximum size, and then present it to the user.

The step 23 is to present the enlarged to-be-scanned image, to the user.

In the first embodiment of the disclosure, the enlarged to-be-scanned image can be presented to the user by presenting only the enlarged to-be-scanned image, in the display area of the display screen without presenting any other information.

Alternatively the enlarged to-be-scanned image can be placed on other information in the display area. As an embodiment, the other information can be faded in transparency in order to highlight the enlarged to-be-scanned image, in the display area to thereby improve the success ratio of scanning the image.

In the first embodiment of the disclosure, the enlarged to-be-scanned image can be placed in the middle of the display area in order to facilitate scanning by the user to thereby improve the success ratio of scanning the image.

The image presenting method according to the first embodiment of the disclosure can be applied to a smart TV without any limitation thereto.

As can be apparent, after the image enlargement request of the user for the to-be-scanned image is received, the to-be-scanned image can be enlarged and then presented to the user so that the user can scan the enlarged image so as to avoid a failure in scanning the to-be-scanned image, which may arise from the small size thereof, thus improving the success ratio of scanning without the need for the user to approach the smart TV and to scan again, which can improve the flexibility of scanning the image and also shorten a response period of time in scanning the image.

Moreover if the user intends to restore the enlarged to-be-scanned image, to the original size, then the user can trigger an operation of restoring the to-be-scanned image, through the digital remote controller, and the smart TV receiving an image restoration request of the user for the to-be-scanned image can shrink the to-be-scanned image, and then present the shrunk to-be-scanned image, to the user. In the first embodiment of the disclosure, the user can trigger the operation of restoring the to-be-scanned image, in the following two particular modes without any limitation thereto:

In correspondence to the first trigger mode, the user moves the focus through the digital remote controller to position the focus onto the enlarged to-be-scanned image, and if the smart TV detects that the focus remains on the enlarged to-be-scanned image, for a longer time length than the preset time length, then the smart TV can determine that the user intends to trigger the operation of restoring the to-be-scanned image, so the smart TV will determine that the image restoration request of the user for the to-be-scanned image is received.

In correspondence to the second trigger mode, the user moves the focus through the digital remote controller to position the focus onto the enlarged to-be-scanned image, and then the user clicks on an “OK” button on the digital remote controller, that is, the user clicks on the enlarged to-be-scanned image, and at this time it can be determined that the user intends to trigger the operation of restoring the to-be-scanned image, so it will be determined that the image restoration request of the user for the to-be-scanned image is received.

If the to-be-scanned image is enlarged by enlarging the to-be-scanned image directly to the maximum size, then the enlarged to-be-scanned image can be shrunk by shrinking the enlarged to-be-scanned image directly to the original size.

If the to-be-scanned image is enlarged by enlarging the to-be-scanned image step by step in such a way that the to-be-scanned image is enlarged by the preset multiple each time the enlargement request of the user for the to-be-scanned image is received, until it is enlarged to the maximum size, then the enlarged to-be-scanned image can be shrunk by shrinking the to-be-scanned image step by step in such a way that the to-be-scanned image is shrunk by the preset multiple each time the restoration request of the user for the to-be-scanned image is received, until it is restored to the original size. Before the to-be-scanned image is shrunk each time, firstly it will be determined whether the size of the to-be-scanned image, which is to be shrunk by the preset multiple is less than the original size of the to-be-scanned image, and if a result of the determination is negative, then the to-be-scanned image will be shrunk by the preset multiple; if a result of the determination is positive, the to-be-scanned image will be shrunk to the original size.

### Second Embodiment

In correspondence to the image presenting method according to the first embodiment of the disclosure, a second embodiment of the disclosure provides an image presenting apparatus structured as illustrated in FIG. 5, the apparatus including:

A first image presenting unit 51 is configured to present a to-be-scanned image to a user;

An enlargement request receiving unit 52 is configured to receive an image enlargement request of the user for the to-be-scanned image;

An image enlarging unit 53 is configured to enlarge the to-be-scanned image under a preset enlargement rule; and

A second image presenting unit 54 is configured to present the to-be-scanned image, which is enlarged by the image enlarging unit 53, to the user.

As an embodiment, the enlargement request receiving unit 52 is configured to determine that the image enlargement request of the user for the to-be-scanned image is received, upon detecting a cursor of the user placed on the to-be-scanned image, for a longer time length than a preset time length.

As an embodiment, the enlargement request receiving unit 52 is configured to determine that the image enlargement request of the user for the to-be-scanned image is received, upon detecting a click operation performed by the user on the to-be-scanned image.

As an embodiment, the image enlarging unit 53 particularly includes:

A first size determining sub-unit is configured to determine a size of the enlarged to-be-scanned image, according to a size of the to-be-scanned image, and a size of a preset display area; and

A first image enlarging sub-unit is configured to enlarge the to-be-scanned image, according to the size, determined by the first size determining sub-unit, of the enlarged to-be-scanned image.

As an embodiment, the image enlarging unit 53 particularly includes:

A determining sub-unit is configured to determine whether the enlarged to-be-scanned image enlarged by a preset multiple goes beyond a boundary of a preset display area;

A second image enlarging sub-unit is configured to enlarge the to-be-scanned image by the preset multiple when a result of the determination by the determining sub-unit is negative;

A second size determining sub-unit is configured to determine a size of the enlarged to-be-scanned image, according to a size of the to-be-scanned image, and a size of the preset display area when the result of the determination by the determining sub-unit is positive; and

A third image enlarging sub-unit is configured to enlarge the to-be-scanned image, according to the size, determined by the second size determining sub-unit, of the enlarged to-be-scanned image.

As an embodiment, the to-be-scanned image is a one-dimension strip code image, a QR code image, or a text image.

The image presenting apparatus can be applied to a smart TV without any limitation thereto.

### Third Embodiment

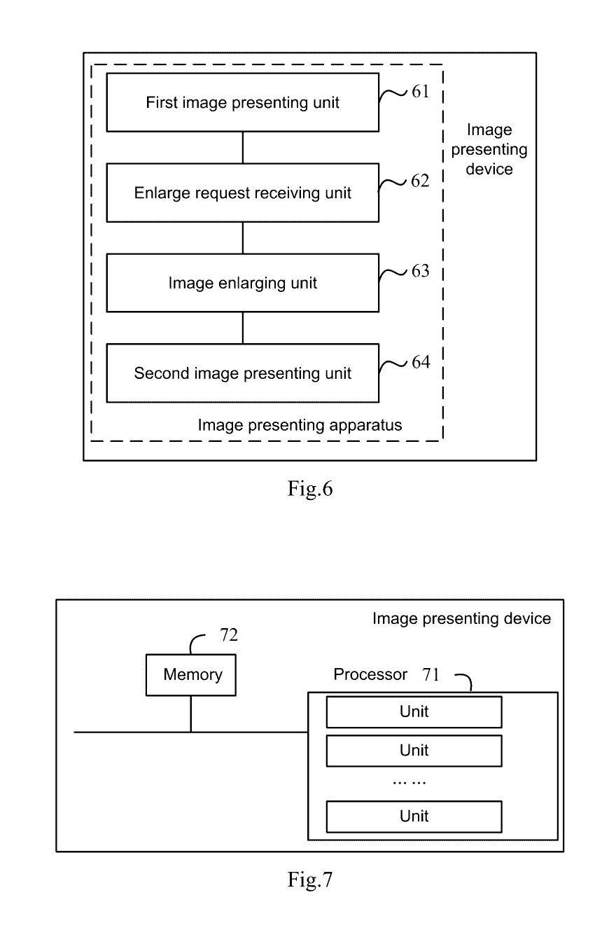

In correspondence to the image presenting method according to the first embodiment of the disclosure, a third embodiment of the disclosure provides an image presenting device structured as illustrated in FIG. 6, including the image presenting apparatus described above, where the image presenting apparatus includes:

A first image presenting unit 61 is configured to present a to-be-scanned image to a user;

An enlargement request receiving unit 62 is configured to receive an image enlargement request of the user for the to-be-scanned image;

An image enlarging unit 63 is configured to enlarge the to-be-scanned image under a preset enlargement rule; and

A second image presenting unit 64 is configured to present the to-be-scanned image, which is enlarged by the image enlarging unit 63, to the user.

As an embodiment, the enlargement request receiving unit 62 is configured to determine that the image enlargement request of the user for the to-be-scanned image is received, upon detecting a cursor of the user placed on the to-be-scanned image, for a longer time length than a preset time length.

As an embodiment, the enlargement request receiving unit 62 is configured to determine that the image enlargement request of the user for the to-be-scanned image is received, upon detecting a click operation performed by the user on the to-be-scanned image.

As an embodiment, the image enlarging unit 63 particularly includes:

A first size determining sub-unit is configured to determine a size of the enlarged to-be-scanned image, according to a size of the to-be-scanned image, and a size of a preset display area; and

A first image enlarging sub-unit is configured to enlarge the to-be-scanned image, according to the size, determined by the first size determining sub-unit, of the enlarged to-be-scanned image.

As an embodiment, the image enlarging unit 63 particularly includes:

A determining sub-unit is configured to determine whether the enlarged to-be-scanned image enlarged by a preset multiple goes beyond a boundary of a preset display area;

A second image enlarging sub-unit is configured to enlarge the to-be-scanned image by the preset multiple when a result of the determination by the determining sub-unit is negative;

A second size determining sub-unit is configured to determine a size of the enlarged to-be-scanned image, according to a size of the to-be-scanned image, and a size of the preset display area when the result of the determination by the determining sub-unit is positive; and

A third image enlarging sub-unit is configured to enlarge the to-be-scanned image, according to the size, determined by the second size determining sub-unit, of the enlarged to-be-scanned image.

As an embodiment, the to-be-scanned image, which is received by the enlargement request receiving unit 62 is a one-dimension strip code image, a QR code image, or a text image.

The image presenting device can be applied to a smart TV without any limitation thereto.

### Fourth Embodiment

In correspondence to the image presenting method according to the first embodiment of the disclosure, a fourth embodiment of the disclosure provides an image presenting device structured as illustrated in FIG. 7, including a memory 71, and one or more processors 72, where the image presenting device further includes:

One or more units, stored in the memory 71, configured to be executed by the one or more processors 72, where the one or more units include instructions for performing steps of:

Receiving an image enlargement request of a user for a to-be-scanned image, after the to-be-scanned image is presented to the user;

Enlarging the to-be-scanned image under a preset enlargement rule; and

Presenting the enlarged to-be-scanned image to the user.

The image presenting device above can be a smart TV or another device capable of displaying.

### Fifth Embodiment

In correspondence to the image presenting method according to the first embodiment of the disclosure, a fifth embodiment of the disclosure provides a computer program product to be used in combination with an image presenting device, where the computer program product includes a readable storage medium, and a computer program mechanism embedded therein, and the computer program mechanism includes instructions for performing steps of:

Receiving an image enlargement request of a user for a to-be-scanned image, after the to-be-scanned image is presented to the user;

Enlarging the to-be-scanned image under a preset enlargement rule; and

Presenting the enlarged to-be-scanned image to the user.

Those skilled in the art shall appreciate that the embodiments of the disclosure can be embodied as a method, a system or a computer program product. Therefore the disclosure can be embodied in the form of an all-hardware embodiment, an all-software embodiment or an embodiment of software and hardware in combination. Furthermore the disclosure can be embodied in the form of a computer program product embodied in one or more computer useable storage mediums (including but not limited to a disk memory, a CD-ROM, an optical memory, etc.) in which computer useable program codes are contained.

The disclosure has been described in a flow chart and/or a block diagram of the method, the device (system) and the computer program product according to the embodiments of the disclosure. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

As defined in this context, the compute readable medium precludes a transitory computer readable medium, e.g., a modulated data signal or carrier wave.

Although the preferred embodiments of the disclosure have been described, those skilled in the art benefiting from the underlying inventive concept can make additional modifications and variations to these embodiments. Therefore the appended claims are intended to be construed as encompassing the preferred embodiments and all the modifications and variations coming into the scope of the disclosure.

Evidently those skilled in the art can make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

1. An image presenting method, comprising:
receiving an image enlargement request of a user for a to-be-scanned image, after the to-be-scanned image is presented to the user;
enlarging the to-be-scanned image under a preset enlargement rule; and
presenting the enlarged to-be-scanned image to the user.

2. The method according to claim 1, wherein receiving the image enlargement request of the user for the to-be-scanned image comprises:
determining that the image enlargement request of the user for the to-be-scanned image is received, upon detecting a focus remaining on the to-be-scanned image, for a longer time length than a preset time length.

3. The method according to claim 1, wherein receiving the image enlargement request of the user for the to-be-scanned image comprises:
determining that the image enlargement request of the user for the to-be-scanned image is received, upon detecting a click operation performed by the user on the to-be-scanned image.

4. The method according to claim 1, wherein enlarging the to-be-scanned image, under the preset enlargement rule comprises:
determining the size of the enlarged to-be-scanned image, according to the size of the to-be-scanned image, and the size of a preset display area; and
enlarging the to-be-scanned image according to the determined size of the enlarged to-be-scanned image.

5. The method according to claim 1, wherein enlarging the to-be-scanned image, under the preset enlargement rule comprises:
determining whether the enlarged to-be-scanned image enlarged by a preset multiple goes beyond a boundary of a preset display area;
enlarging the to-be-scanned image by the preset multiple if the enlarged to-be-scanned image enlarged by the preset multiple does not go beyond the boundary of the preset display area;
determining the size of the enlarged to-be-scanned image, according to the size of the to-be-scanned image, and the size of the preset display area, and enlarging the to-be-scanned image according to the determined size of the enlarged to-be-scanned image, if the enlarged to-be-scanned image enlarged by the preset multiple goes beyond the boundary of the preset display area.

6. The method according to claim 1, wherein the to-be-scanned image is a one-dimension strip code image or a QR code image.

7-18. (canceled)

19. An image presenting device, comprising:
a memory;
one or more processors; and
one or more units, stored in the memory, configured to be executed by the one or more processors, wherein the one or more units comprise instructions for performing steps of:
receiving an image enlargement request of a user for a to-be-scanned image, after the to-be-scanned image is presented to the user;
enlarging the to-be-scanned image under a preset enlargement rule; and
presenting the enlarged to-be-scanned image to the user.

20. A readable storage medium to be used in combination with an image presenting device, wherein the readable storage medium comprises a computer program instructions for performing steps of:
receiving an image enlargement request of a user for a to-be-scanned image, after the to-be-scanned image is presented to the user;
enlarging the to-be-scanned image under a preset enlargement rule; and
presenting the enlarged to-be-scanned image to the user.

21. The device according to claim 19, wherein receiving the image enlargement request of the user for the to-be-scanned image comprises:
determining that the image enlargement request of the user for the to-be-scanned image is received, upon detecting a focus remaining on the to-be-scanned image, for a longer time length than a preset time length.

22. The device according to claim 19, wherein receiving the image enlargement request of the user for the to-be-scanned image comprises:
determining that the image enlargement request of the user for the to-be-scanned image is received, upon detecting a click operation performed by the user on the to-be-scanned image.

23. The device according to claim 19, wherein enlarging the to-be-scanned image, under the preset enlargement rule comprises:
determining the size of the enlarged to-be-scanned image, according to the size of the to-be-scanned image, and the size of a preset display area; and
enlarging the to-be-scanned image according to the determined size of the enlarged to-be-scanned image.

24. The device according to claim 19, wherein enlarging the to-be-scanned image, under the preset enlargement rule comprises:
determining whether the enlarged to-be-scanned image enlarged by a preset multiple goes beyond a boundary of a preset display area;
enlarging the to-be-scanned image by the preset multiple if the enlarged to-be-scanned image enlarged by the preset multiple does not go beyond the boundary of the preset display area;
determining the size of the enlarged to-be-scanned image, according to the size of the to-be-scanned image, and the size of the preset display area, and enlarging the to-be-scanned image according to the determined size of the enlarged to-be-scanned image, if the enlarged to-be-scanned image enlarged by the preset multiple goes beyond the boundary of the preset display area.

25. The device according to claim 19, wherein the to-be-scanned image is a one-dimension strip code image or a QR code image.
